(19) United States
(12) Patent Application Publication
(10) Pub. No.: US 2018/0306935 A1
(43) Pub. Date: Oct. 25, 2018

(54) RADIATION IMAGING APPARATUS, RADIATION IMAGING METHOD, AND STORAGE MEDIUM

(71) Applicant: CANON KABUSHIKI KAISHA, Tokyo (JP)

(72) Inventor: Kota Nakano, Tokyo (JP)

(21) Appl. No.: 16/017,035

(22) Filed: Jun. 25, 2018

Related U.S. Application Data
(63) Continuation of application No. PCT/JP2016/080824, filed on Oct. 18, 2016.

(30) Foreign Application Priority Data
Dec. 28, 2015 (JP) 2015-257325

(51) Int. Cl. G01T 1/29; G01T 1/17; G01T 1/24; G06T 1/60; G06T 1/20

(52) U.S. Cl. CPC G01T 1/2921; G01T 1/17; G06T 1/20; G06T 1/60; G01T 1/247

(57) ABSTRACT

A radiation imaging apparatus includes: a detection apparatus including a plurality of detection units configured to detect radiation irradiated based on a constant tube voltage; and a calculation unit configured to obtain multiple pieces of energy information of the radiation and calculate a photon count corresponding to each of the pieces of energy information based on the detection result of each of the multiple detection units.

### CROSS-REFERENCE TO RELATED APPLICATIONS

This application is a continuation of International Patent Application No. PCT/JP2016/080824 filed on Oct. 18, 2016, and claims priority to Japanese Patent Application No. 2015-257325 filed on Dec. 28, 2015, the entire content of both of which is incorporated herein by reference.

### BACKGROUND OF THE INVENTION

### Field of the Invention

The present invention relates to a radiation imaging apparatus, a radiation imaging method, and a storage medium.

### Background Art

A radiation imaging apparatus is an apparatus that visualizes attenuation of radiation that has transmitted through an object as lightness and darkness of pixels (a grayscale image), based on the radiation intensity (energy) detected by a detection apparatus. Portions inside of the object (e.g., bone, fat, muscle, etc.) have different radiation transmittances, and therefore, for example, at a portion that has little radiation absorption, the radiation intensity that reaches the detection apparatus is high, and at a portion that has high radiation absorption, the radiation intensity that reaches the detection apparatus is low. Thus, the level of attenuation of the radiation differs depending on which portion inside of the object the radiation is transmitted through. With a conventional radiation imaging apparatus, a grayscale image is generated based on the attenuation of the radiation that has transmitted through the object, but if the levels of attenuation of the radiation are the same, the information of the portions inside of the object cannot be obtained as a grayscale image.

PTL 1 discloses a technique of performing multiple instances of radiation imaging at different tube voltages of a radiation generation unit, whereby average photon counts corresponding to the energies of the radiation that was irradiated at the tube voltages is obtained, and thus the portions inside of the object are estimated.

However, with the configuration disclosed in PTL 1, an operator needs to change the tube voltage in order to irradiate the radiation, and if a motion artifact is generated due to the object moving while the tube voltage is being switched, the measurement accuracy will decrease, and therefore the number of photons cannot be calculated with high accuracy based on the measurement result.

### CITATION LIST

### Patent Literature

PTL1: Japanese Patent Laid-Open No. 2009-285356

### SUMMARY OF THE INVENTION

In view of the foregoing circumstance, the present invention provides a radiation imaging technique that can obtain multiple pieces of energy information of radiation irradiated based on a constant tube voltage, and can calculate with high precision the photon counts corresponding to the pieces of energy information, without being influenced by a decrease in the measurement accuracy.

A radiation imaging apparatus according to an aspect of the present invention includes: a detection apparatus including a plurality of detection units configured to detect radiation irradiated based on a constant tube voltage; and a calculation unit configured to obtain a plurality of pieces of energy information of the radiation and calculating a photon count corresponding to each of the pieces of energy information, based on the detection result of each of the plurality of detection units.

A radiation imaging apparatus according to another aspect of the present invention includes: a detection apparatus including a plurality of detection units configured to detect radiation irradiated based on a constant tube voltage; a calculation unit configured to obtain a plurality of pieces of energy information of the radiation and calculating a photon count corresponding to each of the pieces of energy information, based on the detection result of each of the plurality of detection units; and an image generation unit configured to generate an image based on the photon counts.

Further features of the present invention will become apparent from the following description of exemplary embodiments with reference to the attached drawings.

### BRIEF DESCRIPTION OF THE DRAWINGS

The accompanying drawings are included in the specification and constitute a portion thereof, indicate embodiments of the present invention, and are used to illustrate the description and the principle of the present invention.

FIG. 1 is a diagram showing an exemplary configuration of a radiation imaging apparatus according to an embodiment.

FIG. 2 is a diagram showing an exemplary overall configuration of a data processing unit according to an embodiment.

FIG. 3 is a diagram showing a specific configuration of the data processing unit according to an embodiment.

FIG. 4 is a diagram illustrating a flow of imaging processing performed by the radiation imaging apparatus according to an embodiment.

FIG. 5A is a diagram showing a comparative example of a measurement result.

FIG. 5B is a diagram showing a comparative example of a measurement result.

FIG. 6 is a diagram illustrating spectra of radiation used in an experiment.

FIG. 7 is a diagram illustrating an image based on an energy distribution of radiation.

FIG. 8 is a diagram illustrating an image based on a radiation photon count distribution.

FIG. 9 is a diagram illustrating an example in which an image based on an energy distribution of radiation and an image based on a photon count are displayed side by side.

### DESCRIPTION OF THE EMBODIMENTS

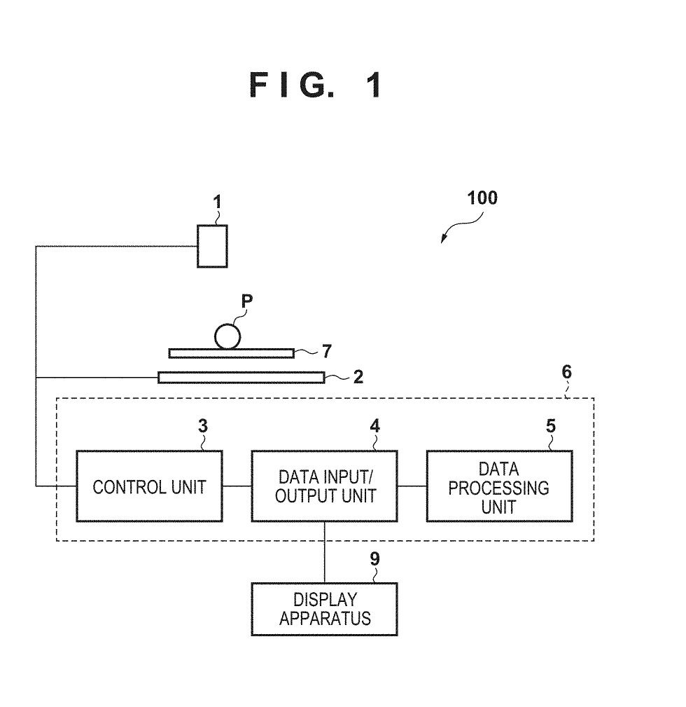

Hereinafter, embodiments of the present invention will be described illustratively and in detail with reference to FIGS. 1 to 9. Note that the constituent elements described in the embodiment are merely examples, the technical scope of the present invention is established by the claims, and there is no limitation to the following individual embodiments.

FIG. 1 is a diagram showing an example of a configuration of a radiation imaging apparatus 100 of an embodiment. As shown in FIG. 1, the radiation imaging apparatus 100 includes a radiation generating apparatus 1, a radiation detection apparatus 2, and an information processing apparatus 6. Note that this configuration is also called a radiation imaging system. The information processing apparatus 6 includes a control unit 3 that controls the operations of the radiation generating apparatus 1 that irradiates radiation and the radiation detection apparatus 2, a data input/output unit 4 that controls input and output of data, and a data processing unit 5 that processes detection data detected by the radiation detection apparatus 2.

The control unit 3 functions as a mechanism control unit to perform position control of the radiation generating apparatus 1 and the radiation detection apparatus 2. Also, the control unit 3 functions as an irradiation control unit to cause the radiation generating apparatus to irradiate radiation based on a constant tube voltage. That is, the control unit 3 performs control to apply a set constant tube voltage to the radiation generating apparatus 1, and thus controls the irradiation of the radiation, performed by the radiation generating apparatus 1. The radiation generating apparatus 1 outputs the radiation based on the control performed by the control unit 3. The control unit 3 functions as an imaging control unit to control the operations of the radiation generating apparatus 1 and the radiation detection apparatus 2, thereby causing multiple instances of radiation imaging to be executed in a predetermined amount of time, and thus detection data (radiation image data) is obtained from the radiation detection apparatus 2.

The radiation detection apparatus 2 has multiple detection units that detect the radiation irradiated based on the constant tube voltage. In a specific configuration, the radiation detection apparatus 2 includes P detection units (radiation detectors) that are arranged in a two-dimensional shape. The radiation detection apparatus 2 uses the P detection units (radiation detectors) to detect the intensity (energy) of the radiation that was output from the radiation generating apparatus 1 to a bed 7 and transmitted through an object P on the bed 7. The P detection units can detect and output the intensity of the radiation that is incident within a designated time frame. The P detection units included in the radiation detection apparatus 2 are arrayed in a two-dimensional shape so as to form multiple rows and multiple columns. The radiation detection apparatus 2 includes a drive unit that drives the multiple detection units in units of rows or in units of columns, and the control unit 3 controls the drive unit to sequentially obtain the detection data corresponding to the total energy of the incident radiation from the multiple detection units. The control unit 3 controls the radiation detection apparatus 2 to obtain the detection results of the radiation incident on the multiple detection units in each certain period.

The multiple detection units included in the radiation detection apparatus 2 output the total energy of the radiation incident on the detection units in each certain period (one frame). As multiple energy levels, the incident radiation is divided into bins of radiation energy segments [Eₖ, Eₖ₊₁] (k=1, 2, . . . , k), and the effective energy value in the k-th energy bin is eₖ. If a photon count having effective energy eₖ in the t-th frame is nₖ^{t}, the total energy (εₜ) of the incident radiation, which is the output value in the t-th frame, is εₜ=e₁n₁^{t}+e₂n₂^{t}+e₃n₃^{t} . . . eₖnₖ^{t}.

In an embodiment of the present invention, when e₁, e₂, e₃, . . . , and eₖ are designated as the values of the energy to be discriminated, the expected values of the photon counts belonging to the radiation energy segments are determined. For example, if the total energy of the radiation has been divided into k radiation energy segments, at least k or more independent pieces of information are needed in order to obtain k unknown values (n₁, n₂, . . . nₖ). For this reason, the necessary number of independent pieces of information is obtained from chronological data of the total energy values [ε₁, ε₂, . . . ε_{T}] output from the detection units in each time frame. Specifically, multiple independent pieces of statistic information are obtained from the chronological data [ε₁, ε₂, . . . ε_{T}]. The multiple pieces of statistic information include information indicating the average value and the variance of the chronological detection results output from the multiple detection units.

In the first embodiment, an example is shown in which the photon count is calculated by obtaining a sample average μ̂ᵢ and a sample variance V̂ᵢ. Note that the multiple independent pieces of statistic information are exemplary and the gist of the present invention is not limited to this example. It is also possible to calculate the photon count using a larger amount of statistic information.

The data input/output unit 4 outputs, to the data processing unit 5, the detection data of the radiation detection apparatus 2 (data indicating the intensity of radiation detected by the detection units of the radiation detection apparatus 2), which was obtained via the control unit 3. Also, the data input/output unit 4 can output the detection data of the radiation detection apparatus 2 to the display unit 9 connected to the data input/output unit 4 and can perform display control of the display unit 9. The data input/output unit 4 can function as a display control unit to display, on the display unit 9, an image based on the photon counts generated by the data processing unit 5. Also, the data input/output unit 4 (display control unit) can display an image based on the detected energy distribution of the radiation and an image based on the photon counts, side by side on the display unit 9. For example, the data input/output unit 4 can also perform display control so as to display a radiation imaging image (imaging image) based on the total energy value output from the detection units and a grayscale image based on the photon counts, which will be described below, side by side on the display unit. Also, for example, the data input/output unit 4 can receive data that is input via an input unit such as a mouse or a keyboard, and the data input/output unit 4 can output the input data to the control unit 3 or the data processing unit 5.

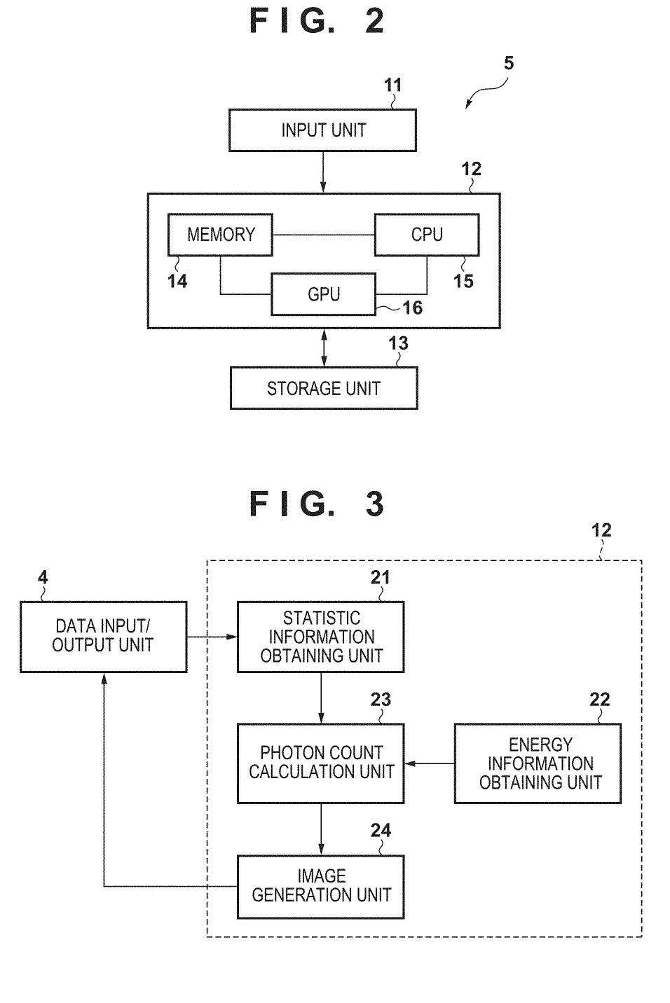

The data processing unit 5 processes detection data detected by the radiation detection apparatus 2. FIG. 2 is a diagram showing an overall configuration of the data processing unit 5. The data processing unit 5 includes an input unit 11 that inputs calculation conditions for processing the detection data and the like, a calculation unit 12 that performs calculation for processing the detection data based on the input calculation conditions, and a storage unit 13 that outputs and stores the results of calculation performed by the calculation unit 12.

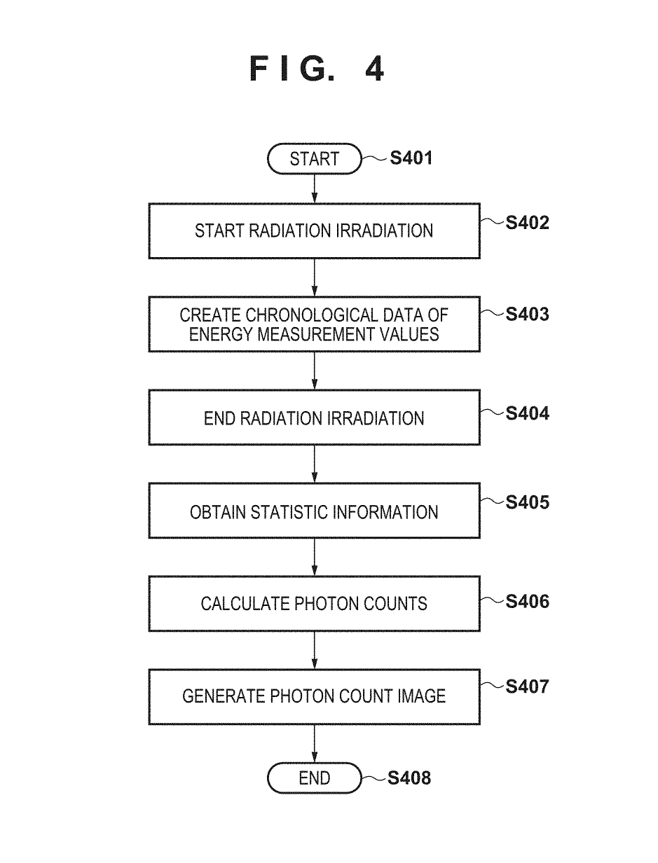

The input unit 11 is constituted by input apparatuses such as a keyboard and a mouse, for example. The storage unit 13 is constituted by a non-volatile memory such as a hard disk or a magneto-optical disk, for example. The calculation unit 12 is constituted by a memory 14, a CPU 15, and a GPU 16, can read the storage content (geometric parameters, programs, and the like) stored in the storage unit 13, and can execute calculation. A grayscale image (photon count distribution image) based on the photon counts obtained through the processing procedure of the present embodiment can be stored in the storage unit 13. A program for instructing the calculation procedure described in FIG. 4 is stored in the storage unit 13, and the calculation unit 12 executes calculation in accordance with the program loaded from the storage unit 13. When the calculation ends, the calculation unit 12 stores the calculation results (photon counts) in the memory 14 or an external storage medium, or outputs the calculation results to the storage unit 13.

Next, the processing of the data processing unit 5 will be described. FIG. 3 is a diagram showing a functional configuration of the calculation unit 12 of the data processing unit 5. The calculation unit 12 obtains multiple pieces of energy information of the radiation and calculates the photon counts corresponding to the pieces of energy information based on the detection result of each of the multiple detection units. The units of the calculation unit 12 shown in FIG. 3 are configured using programs read from the memory 14, the CPU 15, the GPU 16, and the storage unit 13. FIG. 4 is a diagram illustrating a flow of imaging processing performed by the radiation imaging apparatus. Before the imaging operation of the radiation imaging apparatus 100, an energy information obtaining unit 22 obtains multiple pieces of energy information. The energy information obtaining unit 22 receives designation of the values e₁ and e₂ of the energy that is to be discriminated, the designation being input by a user via the input unit 11, for example, and stores the values as the multiple pieces of energy information (information indicating energy levels).

Note that the obtaining of the energy information is not limited to this example, and the energy information obtaining unit 22 can also obtain multiple pieces of energy information based on information indicating a pre-set energy level and information obtained by dividing the spectral distribution width of the radiation. For example, the spectral distribution width of the radiation is Ew, and the information obtained by dividing the spectral distribution width of the radiation is Ew/4. Also, the information indicating the energy level is Ec. In this case, the energy information obtaining unit 22 can obtain Ec−Ew/4 and Ec+Ew/4 as the multiple pieces of energy information. The energy information obtaining unit 22 can also obtain the multiple pieces of energy information by using the effective energies detected by the multiple detection units as information indicating the energy levels. The energy information obtaining unit 22 can also determine the multiple pieces of energy in which the difference of squares of the distributions of the photon counts is at its maximum, based on the detection results of the multiple detection units, such that the contrast of the grayscale image based on the photon counts becomes sharp.

In step S401, when the radiation imaging apparatus receives an instruction to start operation, the processing is advanced to step S402, and due to control performed by the control unit 3, the radiation generating apparatus 1 starts irradiating radiation based on a constant tube voltage. The P detection units (radiation detectors) constituting the radiation detection apparatus 2 detect and output the intensity (energy) of the radiation that has transmitted through the object P on the bed 7 and is incident within a designated time frame. The detection data (detection energy) of the radiation detection apparatus 2 is input to the data processing unit 5 via the control unit 3 and the data input/output unit 4.

In step S403, the memory 14 of the calculation unit 12 stores the intensities (energies) of the radiation detected by the detection units of the radiation detection apparatus 2. For example, the memory 14 stores the radiation intensity values ε_{i,t} (i=1, 2, . . . , P; t=1, 2, . . . , T) output from the i-th detection unit in the t-th frame as the chronological data. According to this processing, the chronological data of measurement values (energy measurement values) of the intensities (energies) of the radiation detected by the detection units of the radiation detection apparatus 2 is created.

In step S404, at the time when the output of the P-th detection unit in the T-th frame ends, the control unit 3 performs control so as to end the irradiation of the radiation performed by the radiation generating apparatus 1.

In step S405, the statistic information obtaining unit 21 obtains multiple pieces of statistic information based on the chronological detection results obtained in each certain period from the multiple detection units. Via the data input/output unit 4, the statistic information obtaining unit 21 reads a string (ε_{i,t}; t=1, 2, . . . T) of detection data (detection energy) values of a detection unit from the first frame to the T-th frame, and obtains the sample average μ̂ᵢ and the sample variance V̂ᵢ as two pieces of statistic information from this string. The following equation indicates a method for calculating a sample average μ̂ᵢ and a sample variance V̂ᵢ as statistic information of the i-th detection unit.

$${\hat{μ}}_{i} = \frac{1}{T} {\sum }_{t = 1}^{T} {ɛ}_{i , t} , {\hat{V}}_{i} = \frac{1}{T - 1} {\sum }_{t = 1}^{T} {( {ɛ}_{i , t} - {\hat{μ}}_{i} )}^{2} \qquad Equation 1$$

The statistic information obtaining unit 21 performs calculation of the above-described statistic information (sample average μ̂ᵢ and sample variance V̂ᵢ) for all of the detection units (i=1, 2, . . . , P) and outputs the calculation results to the photon count calculation unit 23.

In step S406, the photon count calculation unit 23 calculates the photon counts based on the multiple pieces of statistic information. The photon count calculation unit 23 calculates the photon counts based on the multiple pieces of energy information and the multiple pieces of statistic information. The photon count calculation unit 23 calculates the photon counts n_{i,1} and n_{i,2} corresponding to the energy values e₁ and e₂ designated (obtained) via the energy information obtaining unit 22 before the imaging operation of the radiation imaging apparatus 100, for all of the detection units (i=1, 2, . . . , P) (average photon count estimation). Specifically, the photon count calculation unit 23 executes the following calculation. In the photon count and radiation intensity (energy) distribution, if the photon counts are assumed to follow a Poisson distribution in the energy bins, the square of the average value (n²) and the average value (n) of the photon counts satisfy n²=(n)²+n, and therefore the population average (μ) and the population variance (V) of the total energy are as follows.

μ=e₁n₁+e₂n₂, V=e₁²n₁²+e₂²n₂²)−(e₁n₁+e₂n₂)²=e₁²n₁+e₂²n₂ Equations 2

Here, if it is required that the population average and the population variance match the sample average and the sample variance, the relationships in the following equations are satisfied.

e₁n_{i,1}+e₂n_{i,2}= [symbol] ,e₁²n_{i,1}+e₂²n_{i,2}=\hat{V}ᵢ Equations 3

When this simultaneous linear equation is solved for the photon counts n_{i,1} and n_{i,2}, which are unknown values, n_{i,1} and n_{i,2} are as in the following equation. The photon count calculation unit 23 calculates the photon counts no and n_{i,2} using this equation. Note that in Equation 4, E indicates the sample average (average) μ̂ᵢ based on the detection data of a detection unit. Vᵢ indicates the sample variance (variance). Based on the following equations (Equations 4), the photon count calculation unit 23 (calculation unit) can calculate the photon counts n_{i,1} and n_{i,2} corresponding to the two energy values e₁ and e₂ obtained as the multiple pieces of energy information, by using Eᵢ, which indicates the average value, and Vᵢ, which indicates the variance.

$${n}_{i , 1} = \frac{{e}_{2} {E}_{i} - {V}_{i}}{{e}_{1} ( {e}_{2} - {e}_{1} )} , {n}_{i , 2} = \frac{{e}_{1} {E}_{i} - {V}_{i}}{{e}_{2} ( {e}_{1} - {e}_{2} )} \qquad Equation 4$$

In step S407, the photon counts (photon counts n_{i,1} and n_{i,2}) calculated by the photon count calculation unit 23 are sent to the image generation unit 24. The image generation unit 24 generates an image based on the photon counts. The image generation unit 24 generates an image based on the photon counts no and n_{i,2} corresponding to the positions of the multiple detection units arranged in two dimensions. The image generation unit 24 generates a grayscale image based on the photon counts. Also, the image generation unit 24 outputs, to the data input/output unit 4 or the memory 14 of the calculation unit 12, a grayscale image based on the photon counts n_{i,1} and n_{i,2} calculated by the photon count calculation unit 23 and the photon counts n_{i,1} and n_{i,2} corresponding to the positions of the detectors. The data input/output unit 4 can display information obtained from the image generation unit 24 or send the information to an external storage apparatus and store it therein.

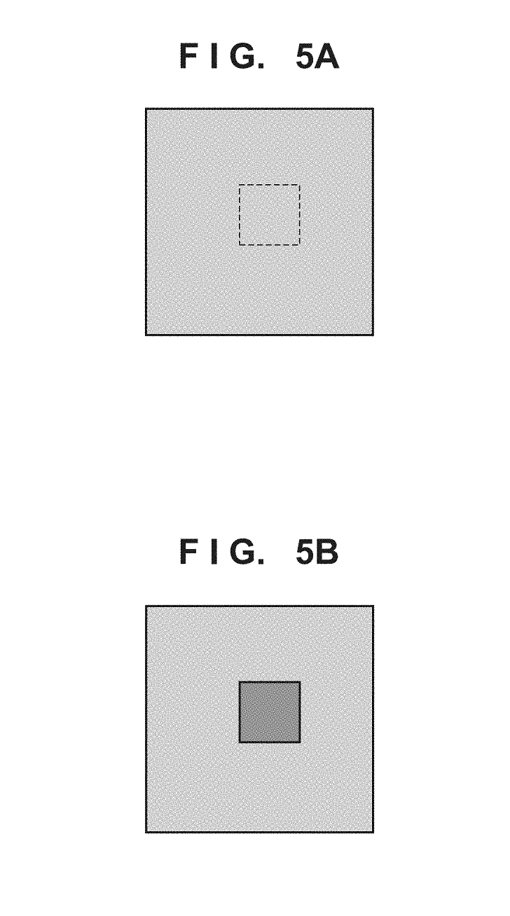

FIGS. 5A and 5B are diagrams illustrating comparative examples of the measurement results. FIG. 5A shows a radiation imaging image (energy image) based on the total energy value of the radiation output from the detection units. If portions (substances) inside of the object that cannot be distinguished between merely using the total energy of the radiation that has passed through the object P and reached the detection units are included, the portions (substances) inside of the object cannot be distinguished between and it is not possible to specify the positions of the portions (substances) inside of the object using the method of detecting the total energy of the radiation. FIG. 5B is a diagram illustrating a grayscale image (photon count distribution image) based on the photon counts. In general, the wavelength of the radiation that is easily absorbed is different for each substance. For example, with a substance that easily absorbs radiation with a long wavelength, if only radiation energy with a long wavelength can be selectively measured, the identity of the substance and the position of the substance inside of the object can be specified as in FIG. 5B.

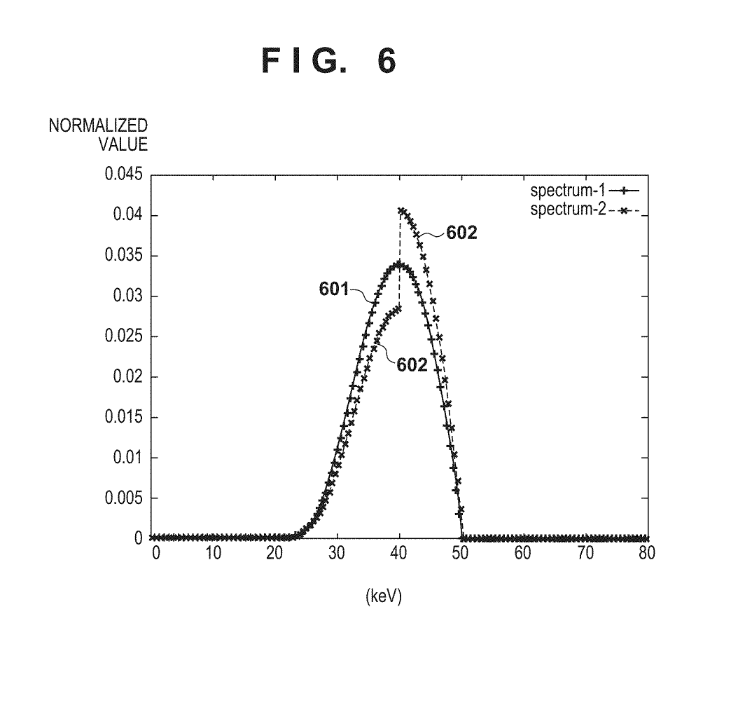

FIG. 6 is a diagram illustrating spectra of radiation used in an experiment. FIG. 6 shows two radiation spectra (spectrum 1 and spectrum 2). In FIG. 6, a spectrum 602 (spectrum 2) is obtained by multiplying the portion less than 40 keV of the spectrum 601 (spectrum 1) by 0.7 (simulating beam hardening) and thereafter performing normalization such that the integrated values are the same. The horizontal axis indicates the energy of the radiation, and the vertical axis indicates the parameters (normalized values) obtained by normalizing the amount of radiation (count).

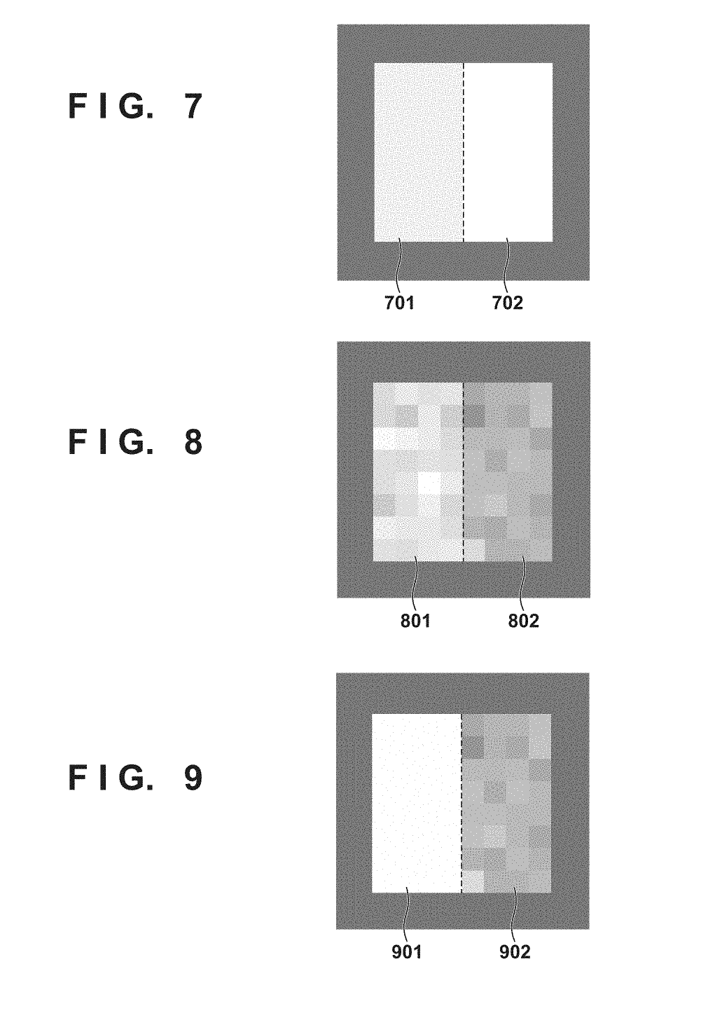

FIG. 7 is a diagram showing a radiation imaging image (energy image) based on the total energy value of the radiation having the two radiation spectra shown in FIG. 6. A region 701 in the left half of the square region indicates a radiation imaging image (energy image) of the spectrum 601 (spectrum 1) and a region 702 in the right half indicates a radiation imaging image of the spectrum 602 (spectrum 2). As shown in FIG. 6, the spectrum 601 (spectrum 1) and the spectrum 602 (spectrum 2) are different, but the contrast difference may be difficult to identify in the energy image indicating the region 701 and the region 702.

FIG. 8 shows an image based on the photon count n₁ corresponding to E₁ when E₁=27.5 keV and E₂=42.5 keV are used as the energy information. A region 801 in the left half of FIG. 8 indicates a grayscale image (photon count distribution image) based on the photon count n₁ calculated for the spectrum 601, and a region 802 in the right half indicates a grayscale image (photon count distribution image) based on the photon count n₁ calculated for the spectrum 602 (spectrum 2). The grayscale images of the region 801 and the region 802 have a contrast difference, and thus it is possible to identify that the amount of photons that reached the region 802 in the right half is less than the amount of photons that reached the region 801 in the left half.

A region 901 in the left half of FIG. 9 indicates an image based on the energy distribution of the radiation (corresponds to the image of the region 702 in FIG. 7), and a region 902 in the right half of FIG. 9 indicates an image based on the photon counts (corresponds to the image of the region 802 in FIG. 8). The data input/output unit 4 (display control unit) can display an image based on the detected energy distribution of the radiation and an image based on the photon counts, side by side on the display unit 9.

According to the present embodiment, it is possible to obtain multiple pieces of energy information of radiation that is irradiated based on a constant tube voltage, and to calculate the photon counts corresponding to the pieces of energy information with high accuracy, without being influenced by a decrease in the measurement accuracy. That is, it is possible to obtain an image based on a highly-accurate photon count distribution while reducing the burden on the operator, without requiring switching of the tube voltage. Also, according to the present invention, it is possible to generate an image of an object including substances that cannot be discriminated between with only a radiation energy image, by using a conventional radiation detection apparatus to create an image of photon counts of radiation having different energies.

### Second Embodiment

In the present embodiment, a configuration will be described in which, when three energies (e₁, e₂, and e₃) have been designated as the values of the energy to be discriminated, the expected values of the photon counts belonging to the radiation energy segments are determined. If the total energy of the radiation is divided into three radiation energy segments, at least three or more independent pieces of information are needed in order to obtain the three unknown numbers (n₁, n₂, n₃). For this reason, the necessary number of pieces of independent information is obtained from chronological data [ε₁, ε₂, . . . ε_{T}] of the total energy values output from the detection units in each time frame. The multiple pieces of statistic information include information indicating an average value, multiple cumulants, and multiple moments of the chronological detection results. In the second embodiment, an example is shown in which the photon counts are calculated using the sample averages and the sample values of second and third cumulants as the multiple independent pieces of statistic information.

The configuration of the radiation imaging apparatus of the present embodiment is similar to that of the first embodiment described above. Hereinafter, a flow of imaging processing performed by the radiation imaging apparatus according to the second embodiment will be described. The flow of imaging processing performed by the radiation imaging apparatus is similar to the flowchart shown in FIG. 4, which was described in the first embodiment.

Before the imaging operation of the radiation imaging apparatus 100, the energy information obtaining unit 22 receives the designation of the values e₁, e₂, and e₃ of the energy to be discriminated, which are input by the user via the input unit 11, and the energy information obtaining unit 22 holds these values. The processing from step S401 to step S404 in FIG. 4 is similar to the processing described in the first embodiment.

In step S405 of FIG. 4, the statistic information obtaining unit 21 reads a string (ε_{i,t}; t=1, 2, . . . , T) of values of the detection data (detected energy) of each detection unit i from the first frame to the T-th frame, and based on the following equation, calculates the sample average μ̂ᵢ, the sample value κ̂_{i,2} of the second cumulant, and the sample value κ̂_{i,3} of the third cumulant as three independent pieces of statistic information from the string. The sample average μ̂ᵢ is as shown in Equation 1.

\hat{κ}_{i,2}=\hat{m}_{i,2}−\hat{μ}ᵢ², \hat{κ}_{i,3}=\hat{m}_{i,3}−3\hat{m}_{i,1}\hat{m}_{i,2}+2\hat{m}_{i,1}³ Equations 5

Here, m̂_{i,2} and m̂_{i,3} are the second moment sample value and the third moment sample value about the origin, and the statistic information obtaining unit 21 calculates the second moment sample value and the third moment sample value using the following equations.

$${\hat{m}}_{i , 2} = \frac{1}{T - 1} {\sum }_{t = 1}^{T} {ɛ}_{i , t}^{2} , {\hat{m}}_{i , 3} = \frac{1}{T - 1} {\sum }_{t = 1}^{T} {ɛ}_{i , t}^{3} \qquad Equations 6$$

The statistic information obtaining unit 21 performs calculation of the above-described statistic information (the sample average μ̂ᵢ, the sample value κ̂^{i,2} of the second cumulant, and the sample value κ̂_{i,3} of the third cumulant) on all of the detection units (i=1, 2, . . . , P) and outputs the calculation results to the photon count calculation unit 23. The photon count calculation unit 23 calculates the photon counts n₁, n₂, and n₃ corresponding to the designated energy values e₁, e₂, and e₃ such that the sample average μ̂₁, the sample value of the second cumulant, and the sample value of the third cumulant match respective theoretical values. The theoretical value (κ₂) of the second cumulant and the theoretical value (κ₃) of the third cumulant are provided according to the following equations.

κ₂=m₂−μ²,κ₃=−m₃−3m₁m₂+2m₁³ Equations 7

Here, in Equation 7, m₂ and m₃ are provided according to the following equations.

m₂=(e₁n₁+e₂n₂+e₃n₃)²,m₃=(e₁n₁+e₂n₂+e₃n₃)³ Equations 8

In the photon count and radiation intensity (energy) distribution, if it is assumed that the photon counts follow a Poisson distribution in each energy bin, nₖ (k=1, 2, 3) satisfies the following equations.

nₖ²=(nₖ)²+nₖ, nₖ³=(nₖ)³+3(nₖ)²+nₖ(k=1,2,3) Equations 9

The following simultaneous linear equation is obtained assuming that the population average (μ=e₁n¹+e₂n₂+e₃n₃) and the sample average μ̂ of the total energy match, and that the sample value κ̂₂ of the second cumulant and the sample value κ̂₃ of the third cumulant match the theoretical value (κ₂) of the second cumulant and the theoretical value (κ₃) of the third cumulant.

μ=\hat{μ}, κ₂=\hat{κ}₂, κ₃=\hat{κ}₃ Equations 10

The photon count calculation unit 23 can calculate the photon counts by solving the simultaneous linear equation in Equations 10 for the photon counts n₁, n₂, and n₃, which are the unknown numbers, under the conditions of Equations 5 to 9. The photon count calculation unit 23 can solve the simultaneous linear equation in Equations 10 numerically by using a numerical calculation method such as Newton's method, for example, but it is also possible to solve the simultaneous linear equation in Equation 10 using another numerical calculation method.

In step S407 of FIG. 4, the photon counts n₁, n₂, and n₃ calculated by the photon count calculation unit 23 are sent to the image generation unit 24. The image generation unit 24 generates and outputs a grayscale image based on the photon counts n₁, n₂, and n₃ corresponding to the positions of the detection units arranged in the two-dimensional shape. According to the present embodiment, it is possible to obtain an image based on a highly-accurate photon count distribution while reducing the burden on the operator, without requiring switching of the tube voltage.

In the first embodiment, an example is shown in which the photon count is calculated by obtaining a sample average μ̂ᵢ and a sample variance V̂ᵢ. Also, in the second embodiment, an example is shown in which the photon count is calculated by obtaining a sample average μ̂ᵢ and sample values of the second and third moments and cumulants as the multiple independent pieces of statistic information. Note that the multiple independent pieces of statistic information are exemplary and the gist of the present invention is not limited to this example. Also, the multiple independent pieces of statistic information as merely examples, and higher moments and cumulants may be used in the configuration of the second embodiment, for example. For example, even in the case where there are Q (>3) types (k) of the multiple pieces of statistic information, it is possible to obtain Q independent pieces of information from observed values (chronological data) and obtain an image based on a more accurate photon count distribution using a method similar to that of the above-described embodiments, that is, by solving a simultaneous linear equation obtained by causing sample values to match theoretical values, under conditions (can be written using a polynomial expression in which a higher moment of the photon counts is an average value) obtained due to the distribution of the photon counts following a Poisson distribution.

According to the first embodiment and the second embodiment, it is possible to obtain multiple pieces of energy information of radiation that is irradiated based on a constant tube voltage, and to calculate photon counts corresponding to the pieces of energy information with high precision, without being influenced by a decrease in measurement accuracy. That is, according to the present invention, it is possible to calculate the photon counts with high precision while reducing the burden on the operator, without requiring switching of the tube voltage.

Also, according to the first embodiment and the second embodiment, it is possible to generate an image of an object including substances that cannot be discriminated between with only a radiation energy image, by using a conventional radiation detection apparatus to image the photon counts of radiation having different energies.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A radiation imaging apparatus comprising:
a detection apparatus including a plurality of detection units configured to detect radiation irradiated based on a constant tube voltage; and
a calculation unit configured to obtain a plurality of pieces of energy information of the radiation and calculating a photon count corresponding to each of the pieces of energy information, based on the detection result of each of the plurality of detection units.

2. A radiation imaging apparatus comprising:
a detection apparatus including a plurality of detection units configured to detect radiation irradiated based on a constant tube voltage;
a calculation unit configured to obtain a plurality of pieces of energy information of the radiation and calculating a photon count corresponding to each of the pieces of energy information, based on the detection result of each of the plurality of detection units; and
an image generation unit configured to generate an image based on the photon counts.

3. The radiation imaging apparatus according to claim 2,
wherein the image generation unit generates the image based on the photon counts corresponding to respective positions of the plurality of detection units arranged in two dimensions.

4. The radiation imaging apparatus according to claim 2, further comprising
a display control unit configured to display, on a display unit, an image based on the photon counts,
wherein the display control unit displays an image based on an energy distribution of the detected radiation and an image based on the photon counts, side by side on the display unit.

5. The radiation imaging apparatus according to claim 1, further comprising
a control unit configured to control operations of a radiation generating unit configured to irradiate radiation and the detection apparatus,
wherein the control unit causes the radiation generating unit to irradiate the radiation based on a constant tube voltage, and
the control unit controls the detection apparatus to obtain the detection results of the radiation incident on the plurality of detection units, each certain period.

6. The radiation imaging apparatus according to claim 5, further comprising
an obtaining unit configured to obtain a plurality of pieces of statistic information based on chronological detection results obtained from the plurality of detection units each certain period,
wherein the calculation unit calculates the photon counts based on the plurality of pieces of statistic information.

7. The radiation imaging apparatus according to claim 6,
wherein the calculation unit calculates the photon counts based on the plurality of pieces of energy information and the plurality of pieces of statistic information.

8. The radiation imaging apparatus according to claim 1, further comprising
an energy information obtaining unit configured to obtain the plurality of pieces of energy information,
wherein the energy information obtaining unit obtains the plurality of pieces of energy information based on information indicating pre-set energy levels and information obtained by dividing a spectral distribution width of the radiation into a plurality of pieces.

9. The radiation imaging apparatus according to claim 8,
wherein the energy information obtaining unit obtains the plurality of pieces of energy information using effective energies detected by the plurality of detection units as the information indicating the energy levels.

10. The radiation imaging apparatus according to claim 6,
wherein the plurality of pieces of statistic information include information indicating an average value and a variance of the chronological detection results.

11. The radiation imaging apparatus according to claim 10,
wherein the calculation unit uses Eᵢ, which indicates the average value, and Vᵢ, which indicates the variance, to calculate photon counts n_{i,1} and n_{i,2} corresponding to two energy values e₁ and e₂ obtained as the plurality of pieces of energy information, based on the following equations:
$${n}_{i , 1} = \frac{{e}_{2} {E}_{i} - {V}_{i}}{{e}_{1} ( {e}_{2} - {e}_{1} )} , {n}_{i , 2} = \frac{{e}_{1} {E}_{i} - {V}_{i}}{{e}_{2} ( {e}_{1} - {e}_{2} )}$$

12. The radiation imaging apparatus according to claim 6,
wherein the plurality of pieces of statistic information include information indicating an average value, a plurality of cumulants, or a plurality of moments of the chronological detection results.

13. A radiation imaging method, comprising
detecting, with a detection apparatus including a plurality of detection units, radiation irradiated based on a constant tube voltage; and
obtaining a plurality of pieces of energy information of the radiation and calculating a photon count corresponding to each of the pieces of energy information based on the detection result of each of the plurality of detection units.

14. A radiation imaging method, comprising:
detecting, with a detection apparatus including a plurality of detection units, radiation irradiated based on a constant tube voltage;
obtaining a plurality of pieces of energy information of the radiation and calculating a photon count corresponding to each of the pieces of energy information based on the detection result of each of the plurality of detection units; and
generating an image based on the photon counts.

15. A non-transitory computer-readable storage medium storing a program for causing a computer to function as the units of the radiation imaging apparatus according to claim 1.
